(19) United States
(12) Patent Application Publication
(10) Pub. No.: US 2003/0154465 A1
(43) Pub. Date: Aug. 14, 2003

(54) Method and system for verifying modules destined for generating circuits

(76) Inventors: Gianmario Bollano, Torino (IT); Donato Ettorre, Torino (IT); Maura Turolla, Torino (IT); Marcello Valentini, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/333,622

(22) PCT Filed: Jul. 17, 2001
(86) PCT No.: PCT/IT01/00378

(51) Int. Cl. G06F 9/45; G06F 9/44; G06F 17/50

(52) U.S. Cl. 717/137; 717/104; 716/4; 716/5

(57) ABSTRACT

Models destined for verification are described at the level of synthesizable description (for example VHDL). The synthesizable description (200) is automatically converted (300) into a C++ model (200′). This allows verification of the correctness of the synthesizable description by comparing the results of a verification carried out on the original description from the cell in C++ with the results of a similar verification of the C++ model obtained by automatic conversion of the synthesizable description. It is also possible to make the C++ model obtained by automatic conversion (200′) to interact with a system model including blocks (201, 202, 203) of a system model at C++ level, in particular with the possibility of producing concurrent events that occur in correspondence with a main timing signal source.

### TECHNICAL FIELD

The present invention concerns a method and system for verifying modules destined for generating circuits.

### BACKGROUND ART

The use of hardware description languages such as VHDL (an acronym for Very High Speed Integrated Circuit Hardware Description Language), and Verilog is a widely used design standard.

Recently, increasing demands, such as the need to provide finished product within very short time limits, has required a further evolution in design methods.

The response to this demand began with the concepts of concurrent engineering and design for re-use. Subsequently instruments were sought to allow hardware/software codesign, and cosimulation between described models, for example in VHDL and models described using high-level programming languages such as C/C++.

In the area of design directed towards the re-use of existing models, the notion of Intellectual Property (IP) was conceived and diffused, i.e. a ‘macroblock’ developed with the intention of being easily included in the design of new integrated circuits.

An IP can be supplied by a company in the form of a geometrical structure for a specific technological process (HARD IP), or a description at the level of logic gates (FIRM IP), or as a description in HDL (SOFT IP).

Real IP libraries therefore exist; in particular, by using the VIP Library™ the applicant can avail of a SOFT IP library specialising in Information and Communication Technology (ICT) applications. The relevant macrocells are highly configurable and flexible, allowing variation of performance in terms of speed, area occupied, and internal architecture, thereby permitting their use in multiple contexts.

Given that the current tendency, as we have seen, is to direct design methodology towards the use of high-level languages, it would, for example, be desirable to be able to use C++ models of IPs already developed for uses such as cosimulation environments. In this manner it would be possible to supply evaluation models that are fully equivalent to descriptions in VHDL in terms of data accuracy and signal timings, but with the advantageous characteristic of quicker simulation times. The availability of SystemC and VHDL descriptions for IP modules would allow evolution, in line with the application and system requirements, towards both synthesis at the hardware and technological mapping level, and to software implementation, which would benefit in turn from the availability of SystemC models. Another advantage of the possible use of C++ would be greater protection of macrocell codes, by making it possible to release a compiled code instead of the source code.

The present invention also tackles the problem that normally faces designers of highly complex system parts, i.e. tests and validation techniques.

In effect, to be sure of the perfect functioning of a hardware module design, it is necessary to insert it into the system for which it is designed, and to check whether it behaves according to specification.

These problems become more significant and difficult to solve in the case of modules destined to be IP programmable and configurable.

The main advantage of the development and use of programmable IPs is the optimisation it offers, and the flexibility of allowing easy insertion into various different types of systems. It should, however, be remembered that the system in which this type of cell is to be inserted often does not exist as a physical reality.

In these conditions, it is difficult to test the functionality of the cells, as it is not easy to reproduce all the possible complex systems in which a certain cell may form a part.

If one considers, by way of example, a cell of a module for decoding convolutional chain codes. The cell obviously has a high degree of programmability, making it suitable for use in decoders capable of implementing different options, not just at an architectural level, but also at an algorithmic level (e.g. to implement different decoding strategies).

Controlling the functioning of the cell accurately would require the design of an entire transmission system, and therefore a decoder containing the designed module, a suitable channel, and a coder with all the characteristics necessary for a complete test.

The design of such a complete system is feasible, with relative ease, even at a high level of abstraction, for example in SystemC.

It should be remembered that SystemC is a new language for the description of hardware (and systems in general) released during 1999: information relating to that language may, for example, be obtained from, the www.systemc.org Internet site.

The relevant description allows for a primary analysis of overall system functioning, in terms of services, essentially at an algorithmic level, or more precisely, operating on interconnected algorithmic modules.

The main advantages of this solution lie in the possibility of beginning from an architectural idea, to introduce the concept of “clock” into a high-level description, availing of a preliminary idea of the timings and communications protocols of the various blocks. In particular, the variables become signals and assume a defined precision.

The design of the transmission system is not the only problem to be solved: the test must actually be of a ‘device under test’ type to assess the whole system, including the surrounding equipment, rather than just the newly designed module or cell.

For example, with reference to the decoder cell mentioned previously, (naturally without being interpreted as limiting the invention), it is necessary to take account of the coder, the channel, the interleaver and all interfaces with memories. Any system malfunction could in fact be due to variables external to the cell being tested.

Such a solution does not appear convincing, also considering the associated simulation times, which are extremely long.

One possibility of bypassing this problem is to create stimuli to pass on to the cell and observe its response to them.

This is certainly the fastest solution, but often it does not cover all the possible cases. This test is therefore definitely valid, but sometimes not exhaustive, as it is not easy to establish the most significant stimuli when the cell is destined to perform a complex function as part of an extremely complex system.

The possible description of the cell at a lower level, i.e. at VHDL level, is undoubtedly advantageous, as the algorithmic modules at C level become logical modules, with precise structural options.

The main problem related to the task of a synthesizable description such as VHDL arises from the fact that, in general, the description comes about as a direct result of an activity carried out by the designer on the basis of his/her individual experience and in a substantially empirical manner. Added to this is the possible risk of errors that can result in a positive test result when it is actually affected by errors, or conversely in the possible test failure and non-validation of a cell that in reality has been correctly designed.

The present invention therefore sets itself the aim of overcoming these drawbacks.

### DISCLOSURE OF THE INVENTION

With this objective, and on the basis of the previous assumptions, the present invention has been developed, featuring the characteristics set out in detail below.

In particular, the invention is configurable as both a method and a corresponding system. The latter can be advantageously configured in the form of a general-purpose processor that, adequately programmed, performs the aforementioned method. The invention therefore also concerns the relevant data product, consisting, for example, of a programme (available on a medium such as a disk or other type of memory and/or “downloadable” from a telematic network) which, when loaded onto a processor of the type described, allows the method to be carried out by the means described in this invention.

### BRIEF DESCRIPTION OF DRAWINGS

The invention will now be described, purely for the purposes of general example, with reference to the annexed designs, of which:

FIG. 1 represents the various procedural phases of the invention in a functional block diagram,

FIG. 2, still using a functional block diagram, represents the simulation and verification phases capable of being implemented as part of the solution proposed by the invention,

FIG. 3 represents the project design flow of a completed product using the solution provided by the invention,

FIG. 4 represents a possible application of the solution proposed by the invention in a functional block diagram.

### BEST MODE FOR CARRYING OUT THE INVENTION

The invention is, above all, capable of performing an ad hoc automatic conversion function, overcoming the constraints imposed by VHDL descriptions in the IP in question. For this purpose, by acting at the preferred moment, the solution adopts the SystemC language for the description of hardware and systems in general.

This instrument, which is essentially a set of classes in C++ which define new types of data and new structures for describing concurrent instructions, or instructions for which the execution order does not modify the final result of the process, allowing definition of a methodology for representing in C++ all the constructs that make up the VHDL for logical synthesis.

After inputting the list of files containing the VHDL description of a complete project, the solution proposed by the invention generates a set of files containing a model described in SystemC. This model, simulated by a simulation kernel supplied by this language, is functionally equivalent to the original VHDL model, and maintains the same level of configurability.

The accuracy of the model is attributable both to the precision of data and of operators (bit-accurate), and to internal and external signal timing (cycle-accurate).

The data structure is made up of a set of classes, each of which represents a construct, or an instruction, of the VHDL. Each class can obviously refer to itself or other classes that make it up, according to a typical VHDL hierarchy. For the purposes of example, a process, which is a concurrent instruction, is made up of an ordered list of sequential instructions.

Availing of the potential offered by a function with objects in C++, it is created so that each class contains within it an analysis function, called parse, and one or more SystemC conversion functions. In the analysis phase, the parsing function for a class interprets the VHDL code, attempting to recognize the instructions that make it up. Once an instruction is recognized, it invokes its own analysis function that, in turn, when it recognises the constructs by which it is defined, invokes the corresponding analysis functions.

In substance, this solution is based on the following steps:

providing a set of classes, each of which is capable of representing an instruction or a VHDL construct, each class containing an internal parsing function, and at least one SystemC conversion function.

applying the parsing function to the VHDL code for each of the said classes, so as to recognise corresponding instructions or constructs.

once an instruction or a construct is recognised, memorising the relevant information thus obtained according to the hierarchical structure of the VHDL.

applying the conversion function for SystemC to that information while keeping its aforementioned hierarchical structure, so as to generate, by the effect of the conversion to SystemC, a C++ model that keeps the VHDL hierarchical structure.

The use of the hierarchy in the analysis phase of the VDHL code allows considerable simplification of both comprehension and the recognition of any errors in the code. Furthermore, it is possible to accurately detect the specific context of any analysed instruction or construct at any time. With an example, an expression in VHDL can be found inside a condition, or as the subject of a function, or as the initialisation value of a constant, and so on. Thanks to the hierarchical approach of the code analysis, the solution proposed by the invention adopts an optimised method for organising the information associated with it by referring to the class containing the analysed expression.

Finally, the translation phase exploits the hierarchical structure in analogue mode, in which the information relating to the VHDL code is memorised.

Beginning from the entity, or from the VHDL construct that defines the model interface, the translation function invokes the translation functions of instructions and the constructs that make them up in hierarchical mode, using a conversion methodology.

For easier use, parameters are introduced, to be indicated on the command line, allowing a choice of which design blocks are to be converted, where files must be written in SystemC, and whether or not to enable the generation of files containing information on the interface of each of the translated blocks.

In the FIG. 1 block diagram, block number 100 represents the parsing phase in which the VHDL code is taken from a related 102 database, following the order and hierarchy shown in the list of instructions (file list-TXT), generically represented by block 104.

The result of the parsing phase is made up, on the one hand, of the generation of the respective interface module information (106) and, on the other hand by the generation of modules translated onto SystemC, (represented by block 108) According to an important characteristic of the invention, these translated modules are organised in the same order and the same hierarchy as the original VHDL code.

Reference 110 indicates the operation of automatic creation of the stimuli generator, such as with that used to validate the VHDL model. The stimulus generator is shown at block 112, while block 114 represents the so-called ‘test bench’.

This latter block is intended for use, together with generator 112, the 108 modules, and any available set of libraries in SystemC shown by block 116, to define the input to a block 118.

This latter block represents the compilation and C/C++ linking function, capable of originating the executable module 120, as a final result in binary language.

The set of functions described above is capable of being activated by a general purpose processing system programmed according to criteria known by experts in the sector who know its intended use, as described above in detail. In particular, a useful source of reference on the implementation of the parsing function as described above can be found at the website at www.vhdl.org/vi/.

The invention also, but in an autonomous manner, concerns the relevant data product (consisting, for example, of a programme available on a medium such as a disk or other type of memory and/or “downloadable” from a telematic network) that, when loaded onto a processor of this type, allows the method to be performed in the manner described.

Once the 108 model has been obtained in SystemC from the VHDL model, it is useful to be able to verify the complete equivalence of the two models in terms of functionality and signal timings.

By availing of the simulation environments already defined for models in VHDL, it is possible to launch the simulation and register the model's input and output waveforms in a file. This information is subsequently converted into a tabular format, in a familiar form.

At this point a simulation environment capable of reading the waveforms in tabular form is created in SystemC, applying a translated model and recording input and output in another file using the same format. The equivalence of the files can be verified from a comparison of the two models.

Since the structure of the simulation environment does not change much from model to model, a function has been developed to generate a custom-made simulation environment from information on the interface of a block.

The result is a complete simulation environment, where it is possible to reconfigure the model by changing the desired parameters in a text file. The stimuli patterns are the same as those adopted for the validation of the synthesised VHDL code, or can be specified by the user. The complete equivalence between Soft IP VHDL can also be used to produce output in graphic form (waveform), identical to that used for VHDL simulations.

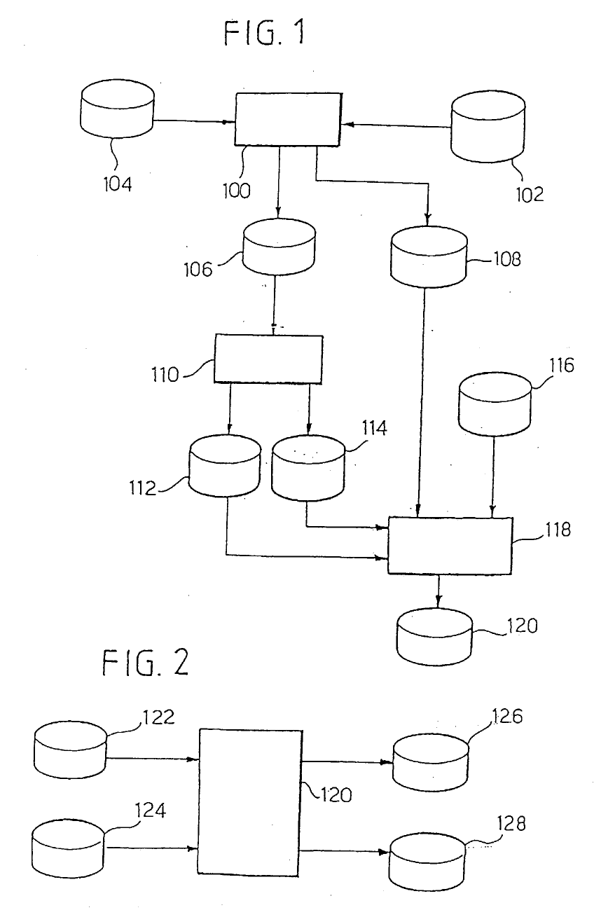

In this respect, in the diagram in FIG. 2, block 122 represents the set of waveforms in tabulated form, destined for application in the executable module, indicated, as in FIG. 1, by reference 120.

Block 124 on the other hand, indicates a configuration file, the essential function of which is to assign the simulation parameters to the executable module 120.

The corresponding waveforms generated by model 120 are made available in the preferred manner, as output in tabular formant (block 126), or in graphic waveform (block 128)

It is thus possible to compare the waveforms from set 126 and/or set 128 with their corresponding waveforms, which can be obtained by applying the same stimuli as set 122—and the same stimulation parameters as block 124—to the VHDL description from which the C++ model represented by block 120 is derived.

This comparison, which can be activated by any known method, can perform a full simulation and verification of the complete alignment of C++ module with its equivalents in VHDL.

In this case also, the set of functions described is capable of being activated by a general purpose processing system programmed according to criteria known by experts in the sector who know its intended use, as described above in detail. This is particularly useful in terms of the accuracy of the model at cycle and bit level, and/or the option to make products available in the form of easily comparable tables, or in graphic form for easy comprehension.

From this point of view also, the present invention, in an autonomous manner, concerns the relevant data product (consisting, for example, of a programme available on a medium such as a disk or other type of memory and/or “downloadable” from a telematic network) that, when loaded onto a processor of this type, allows the method to be performed in the manner described.

The availability of the SystemC source code makes the task possible in development environments created for different software platforms, or to new tools created for cosimulation between algorithmic models (regardless of hardware or software) and HDL code (regardless of the technology, but orientated towards logical synthesis).

In particular, the solution proposed by the invention is capable of operating with SOFT Intellectual Properties, or VHDL codes that are:

synthesizable (translatable into logic with automatic tools)

independent of technology (ASIC, FPGA)

re-configurable for various requirements (performance or costs) and applications.

The solution proposed by the invention has been developed and tested on the Intellectual Properties library developed by the Applicant (called a VIP Library™), where each cell is:

re-configurable (VDHL generics),

provided with simulation scenarios, syntheses, documents, and

Conforms to organisation rules and coding for SystemC libraries.

These libraries, developed by the Synopsys company, and adopted by the majority of CAE software producers, as well as ASIC and component and systems producers, permit the creation of system models, both SW and HW, before deciding the specific type to be created (partitioning, co-simulation) The libraries are useful for scanning the algorithms and architectures and to ensure different grades of numerical accuracy and synchronisation, on the basis of the desired type of abstraction.

The solution proposed by the invention therefore allows the generation of SystemC models for the simulation and assessment of SOFT IP, re-configurable to bit and clock cycle accuracy with the VHDL model. As preferred embodiment, the solution proposed by the invention adopts an ANSI C++ code, based on the 1.0 libraries (V0.9 style) and translates synthesizable VHDL (Synopsys DC-style):

entity, architecture

generics (bit width, generate)

process

structural descriptions

1D-2D array variables

methods, functions

enumerated data types.

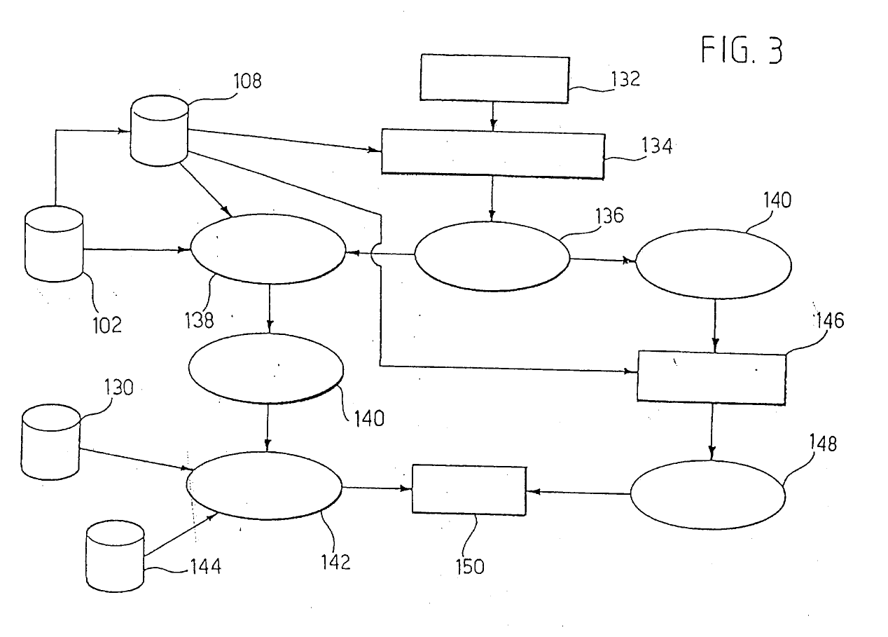

In this respect, the diagram shown in FIG. 3 illustrates a typical software/hardware design method that can be activated by using the present invention

In the diagram in question, references 102 and 130 indicate two sets of IPs available in IP and VHDL forms respectively: (set 102—already shown in FIG. 1) and IP hardware (set 130).

Block 108 represents the set of modules in SystemC obtained from set 102, according to the criteria described above in reference to FIG. 1.

Blocks 132 and 134 represent the definition of system specifications and the consequent functional simulation of the system itself, the latter activated using module 108, benefiting from the fact that these are no longer described in VHDL, but in SystemC, which, above all, makes the simulation much faster.

Block 136 represents the partitioning between hardware and software solutions, in order to evolve the design methodology along two parallel and concurrent lines, originating from blocks 138 and 140.

The first line of evolution, in terms of scanning the hardware architecture, can be carried out in cooperative mode both with set 102 (described at VHDL level), and with set 108 (described in SystemC). The next stage is the hardware synthesis (block 140), and the mapping of the technology.

The latter phase, represented by block 142, is carried out in cooperation with set 130 and any existing further library (144).

The second line of evolution, at the software implementation level, is the generation of a SystemC code (block 146) with the possibility of exploiting one or more modules deduced from set 108, benefiting from their availability in SystemC.

Block 148 represents possible system development at the microprocessor or similar level, capable of being conducted in interactive mode with the technology-mapping phase (block 142), in order to arrive, in the phase depicted at 150, at the creation of a monolithic system (System On a Chip or SOC).

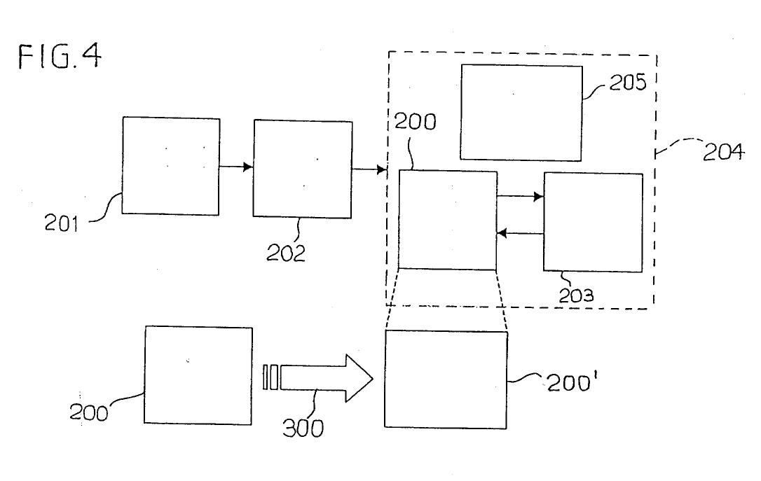

The diagram in FIG. 4 illustrates the possible application of the solution proposed by the present application to the verification and validation function of a 200 module for generating circuits constructed, for example, using a module destined for use in generating circuits for decoding convolutional chain codes.

It should be remembered once again that the example shown as such must not in any manner be interpreted as limiting the scope of the invention.

This specific example has been provided solely in order to refer to a classic situation in which the verification and validation of the module (cell) implies the possibility of reproducing the interaction methods of the same cell with other modules included in the same system (such as, for example, an encoder 201, a channel 202, or an interleaver 203), which would make them all available in SystemC at a description level, i.e. at an essentially algorithmic level.

Reference number 204 indicates the overall verification and validation environment in which the cell destined for verification and validation (identified by number 200 for reasons that will become apparent later) is made to interact with other modules 201, 202 and 203 under the supervision of a memorisation and control unit, shown generally by number 205.

This occurs according to widely known criteria which do not require a detailed description, and because these criteria—besides being well known—are not in themselves significant for the purposes of understanding the invention.

It is enough to remember that this method allows operation “halfway” between a hardware (HDL) and software (C, C++), simulating a complex system with user-defined precision. All of this occurs even before deciding which blocks will be created at software or hardware level.

In particular, thanks to the characteristics of SystemC, this method of method allows introduction of the concept of concurrent events occurring in parallel correspondence with a main timing (clock) signal. This allows the system to be divided into blocks that work concurrently, exchanging data through control interfaces and signals. Each block implements a function described in algorithmic mode, which is very convenient when verifying the functionality of the cell.

Besides producing an object code that is faster to execute, the high-level description in SystemC lends itself to an optimal algorithmic description of a function.

The solution proposed by the invention is based on the option of describing the real cell in the form of a synthesizable description, such as, for example, a VHDL description (this denomination being understood as including any hardware description language corresponding to that standard, such as, for example, Verilog.

This VHDL description-represented in FIG. 4 by block 200—is therefore converted (or “translated”) automatically into a description in SystemC—represented by block 200′. This “translated” description is capable of being directly used in verification and validation environment 204 to interact with the various other models present therein.

This conversion or automatic translation action (represented by block 300 in the diagram at FIG. 4) corresponds in practice to the application—by the VHDL description represented by block 200—of the method described above in relation to FIGS. 1 to 3.

In actual fact, the description of the cell at VDHL level (represented by block 200 in FIG. 4) can be seen as corresponding to block 102 of the diagram in FIG. 1. The description in SystemC, represented in FIG. 4 by block 200′, used for verification and validation, corresponds to module 120 of the diagram in FIG. 1.

It should be appreciated that this solution, with relatively little effort, allows for the destined cell to be verified and validated in a low-level SystemC description, equivalent to VHDL. It is then easier to insert the new “copy” cell 200′ into the transmission system.

The verification function above all uses a single simulation kernel, overcoming various problems such those related to the hypothetical direct insertion of a VHDL module into a system in SystemC and proceeding through the passage of stimuli from files, and returning the responses to the system. this solution, besides its extreme complexity, comes up against the problem of stopping the simulations while preserving the state of the modules in order to be able to recommence once the return signals have reverted to the point they were at when the system was stopped.

In particular, the solution proposed by the invention allows a direct comparison between the simulation results obtained:

on one hand, using an original description of a C level module (C++), and

on the other hand, using a further description of the same module, always at level C. The further description is, however, obtained by the conversion or automatic translation from a description, such as a VHDL description. This conversion or translation occurs according to the methods described above.

A comparison of the results of simulation (in practice: the comparison of results of simulation obtained against the same stimuli in either case) allows verification of the correctness and completeness of the VHDL description.

In particular, once the identity or substantial identity of the simulation results obtained in the two cases have been verified, it is possible to verify the correctness of the VHDL description.

Where there are discrepancies, it is possible, including by evaluating the nature and extent of the discrepancies found, to intervene in the VHDL description and to modify it until the comparative results show correctness of the description in VDHL (if it is by an iterative process comprising successive steps of modification and verification).

Naturally, without prejudice to the principle of the invention, the detailed functioning and methods of implementation allow for wide variation from the above descriptions and illustrations, without deviating from the scope of the present invention. This assertion applies particularly, but not exclusively, to a possible general application of the solution proposed by the invention for verifying modules for the generation of circuits of any kind, and/or their relative synthesizable descriptions of any kind.

1. Method for verifying modules destined for generating circuits (200, 200′), characterised in that it includes the following steps:
describing the modules to be verified as a synthesizable description (200),
automatically converting said synthesizable description (200) into a corresponding C++ model (200′), and
automatically verifying the modules by operating on said C++ model (200′) obtained by the automatic conversion.

2. Method in accordance with claim 1, characterised in that it also includes the following steps:
describing the modules to be verified as an original description at C++ level, and
verifying the modules using both the original description at C++ level, and using said C++ model (200′) obtained by automatic conversion.

3. Method in accordance with claim 2, characterised in that it includes the step of comparing the results of the verification by using said original description at C++level, and the results of the verification obtained using said C++ model obtained by automatic conversion, whereby the result of this comparison is indicative of the correctness of the synthesizable description (200).

4. Method in accordance with claim 1, characterised in that it also includes the following steps:
generating a C++ system model in which the module subjected to verification is capable of being inserted, said system model including blocks (201, 202, 203) that each implement a function described in algorithmic mode,
performing the verification by causing the said module, described as a C++ model (200′), obtained by automatic conversion, to interact with the blocks (201, 202, 203) of said system model.

5. Method in accordance with claim 4, characterised in that said blocks (201, 202, 203) work in a concurrent manner, preferably implementing concurrent events that occur in correspondence with a main timing signal source.

6. Method in accordance with any of the preceding claims, characterised in that it also includes the following steps:
selecting, a description in VHDL (200) as said synthesizable description.
providing(100) a set of classes, each of which is capable of representing an instruction or a construct of the VHDL description of the modules to be verified, each class containing an internal parsing function, and at least one SystemC conversion function,
applying the parsing function to the VHDL code for each of said classes, so as to recognise corresponding instructions or constructs,
once an instruction or a construct is recognised, to memorise the relevant information thus obtained according to the hierarchical structure of the VHDL, and
applying the conversion function to SystemC to said information while keeping said hierarchical structure, so as to generate, by the effect of the conversion to SystemC, said C++ model that keeps the VHDL hierarchical structure.

7. Method in accordance with claim 6, characterised in that includes at least one of the following steps:
selectively identifying macroblocks of information in said VHDL description to be used for the creation of said models,
identify the writing position of the files in SystemC, and
selectively enabling the generation of files containing interface information of translated blocks.

8. Method in accordance with claim 6 or claim 7, characterised in that it includes the step of providing means (112, 114) to generate stimuli conforming to those used to validate the VHDL model, and the step of applying said stimuli to said C++ model generated by said SystemC conversion function.

9. Method according to any of the preceding claims 6 to 8, characterised in that it includes the step of creating said C++ models in the form of the respective executable models obtained by compilation and linkage (118) of the results obtained by said SystemC conversion function.

10. Method in accordance with claims 8 and 9, characterised in that said compilation and linkage step (118) is also applied to said means (112, 114) to generate stimuli conforming to those used to validate the VHDL model (110).

11. Method in accordance with claim 9, characterised in that it includes the step of compiling and linking data collected from libraries in SystemC (116).

12. Method in accordance with any of the preceding claims 6 to 11, characterised in that it also includes the following steps:
providing a set of stimulation waveforms (122) for the simulation and/or verification of the VHDL code,
applying the waveforms of said set (122) to the C++ models (120) created from the VHDL descriptions, so as to obtain a respective set of output waveforms (126, 128), and
comparing said respective set of output waveforms (126, 128) with the output waveforms resulting from the application of the stimulation waveforms of said set (122) to said VHDL descriptions for the purposes of simulation and verification of said C++ models (120).

13. Method in accordance with claim 12, characterised in that said respective set of output waveforms includes waveforms in tabular form (126) and/or in graphic form (128).

14. A processing system for implementing the method in accordance with any of claims 1 to 13.

15. Data processing product including programme codes, wherein said data processing product, when loaded onto a processing system, is capable of implementing the method described in any of claims 1 to 14.
